(19) United States
(12) Patent Application Publication
(10) Pub. No.: US 2011/0142685 A1
(43) Pub. Date: Jun. 16, 2011

(54) PUMP UNLOADER VALVE AND ENGINE THROTTLE SYSTEM

(75) Inventor: Richard J. Gilpatrick, Whitewater, WI (US)

(73) Assignee: Briggs & Strantton Corporation

(21) Appl. No.: 12/639,864

(22) Filed: Dec. 16, 2009

(51) Int. Cl. F04B 49/20; F16K 31/44

(52) U.S. Cl. 417/34; 417/279; 251/279

(57) ABSTRACT

A pressure washer system includes an engine, a water pump, a sprayer, an unloader, and a link. The engine has a throttle system designed to control the speed of the engine. The water pump includes an inlet, a pumping mechanism, and an outlet. The pumping mechanism is designed to be driven by the engine. The sprayer is attached to the outlet of the water pump. The unloader is designed to direct water toward the inlet of the water pump when the unloader is in a first configuration, and to direct water toward the sprayer when the unloader is in a second configuration. Water pressure generated when the sprayer is not actuated moves the unloader to the first configuration. The link connects the unloader and the throttle system of the engine, where the link is designed to adjust the throttle system to a first engine speed when the unloader is in the first configuration, and to adjust the throttle system to a second engine speed when the unloader is in the second configuration.

### BACKGROUND

The present disclosure relates generally to the field of motorized pumps, such as pumps for pressure washers. More specifically, the present disclosure relates to a pump having an unloader valve designed to provide control feedback to a throttle system of an engine driving the pump.

A pump for a pressure washer is typically driven by a motor, such as small internal combustion engine. The motor drives a cam, which translates pistons for pressurizing water. The pressurized water is then controllably released through a sprayer, such as a pressure washer spray gun. The spray gun may include a trigger to controllably allow or stop water from flowing out of the spray gun. When the trigger is in a closed position, back pressure builds in a hose coupling the pump to the spray gun. To help alleviate the back pressure, such a pump typically includes an unloader (e.g., flow-diverting valve).

The unloader includes a valve responsive to trapped pressure between the pump and the spray gun. When the spray gun is actively spraying, the unloader allows water to flow to and out of the spray gun. However, when the spray gun is not spraying but the pump is active, the unloader opens a bypass conduit allowing the pressurized water to flow from the outlet of the pump, back into the inlet of the pump, forming a recirculation circuit. Recirculation of the water reduces loading on the motor and lowers pressures within the pump, increasing the life of pump components and saving energy.

### SUMMARY

One embodiment of the invention relates to a pressure washer system. The pressure washer system includes an engine, a water pump, a sprayer, an unloader, and a link. The engine has a throttle system designed to control the speed of the engine. The water pump includes an inlet, a pumping mechanism, and an outlet. The pumping mechanism is designed to be driven by the engine. The sprayer is attached to the outlet of the water pump. The unloader is designed to direct water toward the inlet of the water pump when the unloader is in a first configuration, and to direct water toward the sprayer when the unloader is in a second configuration. Water pressure generated when the sprayer is not actuated moves the unloader to the first configuration. The link connects the unloader and the throttle system of the engine, where the link is designed to adjust the throttle system to a first engine speed when the unloader is in the first configuration, and to adjust the throttle system to a second engine speed when the unloader is in the second configuration.

Another embodiment of the invention relates to a system for pressurizing a fluid. The system includes an engine, a pump, an unloader, and a link. The engine has a throttle system designed to control the speed of the engine. The pump includes an inlet, a pumping mechanism, and an outlet, where the pumping mechanism is driven by the engine. The unloader is attached to the pump and designed to open a bypass conduit directing fluid from the outlet of the pump to the inlet of the pump when the unloader is in a first configuration, and to close the bypass conduit when the unloader is in a second configuration. The link connects the unloader to the throttle system of the engine, where the link is designed to adjust the throttle system to a first engine speed when the unloader is in the first configuration, and to adjust the throttle system to a second engine speed when the unloader is in the second configuration.

Yet another embodiment of the invention relates to an unloader system for use with a pump. The unloader system includes a housing, a valve plug, a spring, and a link. The housing is designed to be fastened to an outlet of the pump. The valve plug has a first position and a second position relative to the housing. The spring biases the valve plug toward the second position. The link is connected to the valve plug, and is designed to communicate movement of the valve plug to control the pump.

Alternative exemplary embodiments relate to other features and combinations of features as may be generally recited in the claims.

### BRIEF DESCRIPTION OF THE FIGURES

The present invention will become more fully understood from the following detailed description, taken in conjunction with the accompanying figures, wherein like reference numerals refer to like elements, in which:

FIG. 1 is a perspective view of a pressure washer system according to an exemplary embodiment of the invention.

FIG. 2 is a perspective view of a water pump of the pressure washer system of FIG. 1.

FIG. 3 is a bottom view of the water pump of FIG. 2.

FIG. 4 is a perspective view of an unloader according to an exemplary embodiment of the invention.

FIG. 5 is an exploded view of the unloader of FIG. 4.

FIG. 6 is a side view of the unloader of FIG. 4.

FIG. 7 is a perspective view of an engine according to an exemplary embodiment of the invention.

FIG. 8 is schematic diagram of a pressure washer system according to an exemplary embodiment of the invention.

### DETAILED DESCRIPTION

Before turning to the figures, which illustrate the exemplary embodiments in detail, it should be understood that the present invention is not limited to the details or methodology set forth in the description or illustrated in the figures. It should also be understood that the terminology is for the purpose of description only and should not be regarded as limiting.

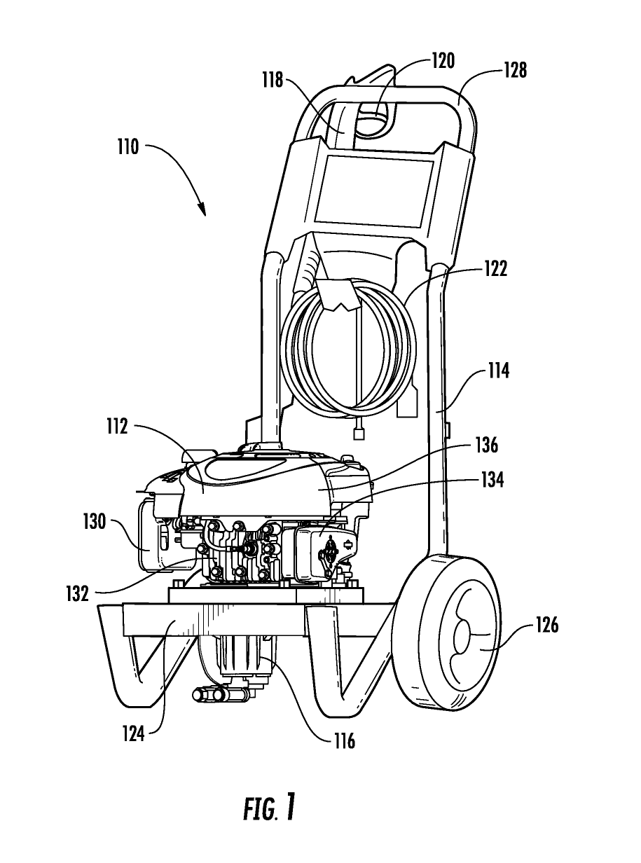

Referring to FIG. 1 a pressure washer system 110 includes an engine 112, a support frame 114, and a pump 116. The engine 112 drives the pump 116, and both the engine 112 and the pump 116 are coupled to the support frame 114. In some embodiments, the pressure washer system further includes a sprayer, such as a spray gun 118 including a trigger 120 to actuate the spray gun 118. A high-pressure hose 122 may be used to couple the spray gun 118 to the pump 116.

In some embodiments, the support frame 114 further includes a base plate 124, wheels 126, and a handle 128. The engine 112 is fastened to a top of the base plate 124 and the pump 116 is fastened to an underside of the base plate 124. In some embodiments, the engine 112 is an internal combustion engine (e.g., four-stroke cycle), and further includes an air intake 130, a block 132 (e.g., combustion chamber, cylinder, cylinder head, etc.), a muffler 134, a shroud 136, and other engine components. A power take-off (e.g., crankshaft or extension therefrom) of the engine 112 may be coupled to the pump 116, through a hole in the base plate 124, to drive a pumping mechanism of the pump 116 (e.g., radial or axial cam coupled to pistons).

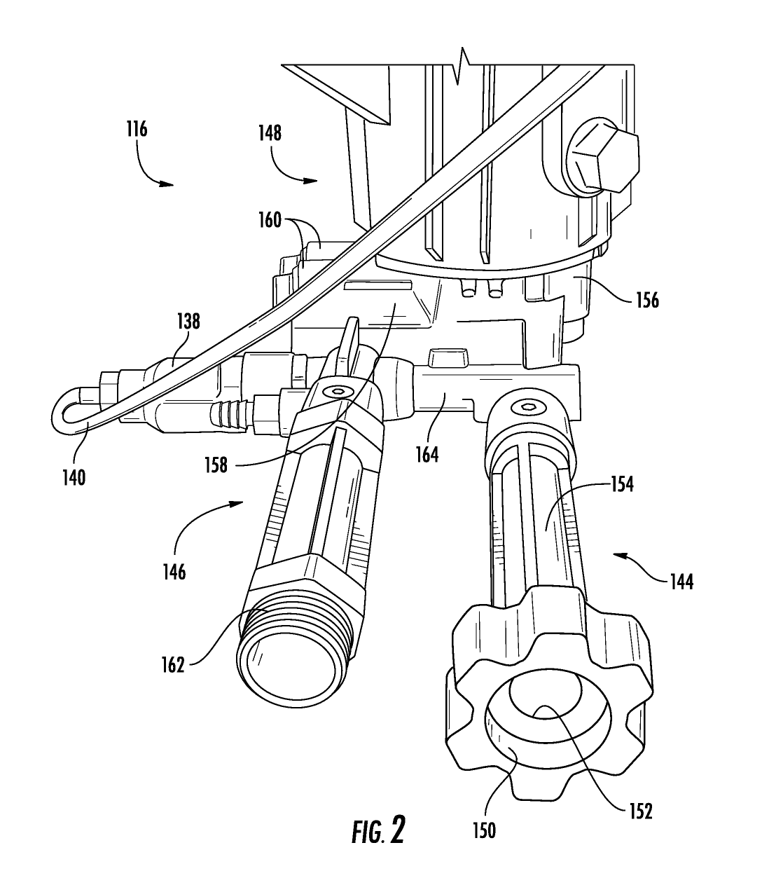

Referring to FIGS. 1-2, an unloader 138 (FIG. 2), such as a trapped pressure unloader, is coupled to the pump 116 of the pressure washer system 110. Extending from the unloader 138 is a link 140 (e.g., communication line, connection, etc.), configured to couple the unloader 138 to a throttle system of the engine 112, to regulate the speed of the engine 112 as a function of the unloader 138 configuration (e.g., whether and to what degree the unloader valve is open). In other embodiments, the unloader 138 is mounted to a pump driven by an electric motor, and the link 140, coupled to the unloader 138, is used to control the amount of electricity supplied to the electric motor, or to control a transmission coupling the motor to the pump.

While the pump 116 of FIG. 1 is primarily directed to pressurizing water for the pressure washer system 110 or like system, the system described herein may be used with a broad range of equipment. In some embodiments, an unloader on a pneumatic pump includes a link that is coupled to a prime mover driving the pneumatic pump. In other embodiments, an unloader on a fluid pump of an extruder is linked to a prime mover driving the fluid pump. In some embodiments, the unloader is a trapped pressure unloader. In other embodiments, the unloader is flow activated, where a valve is responsive to a water flow rate passing therethrough. When decreased flow rate is sensed, the valve opens a bypass conduit.

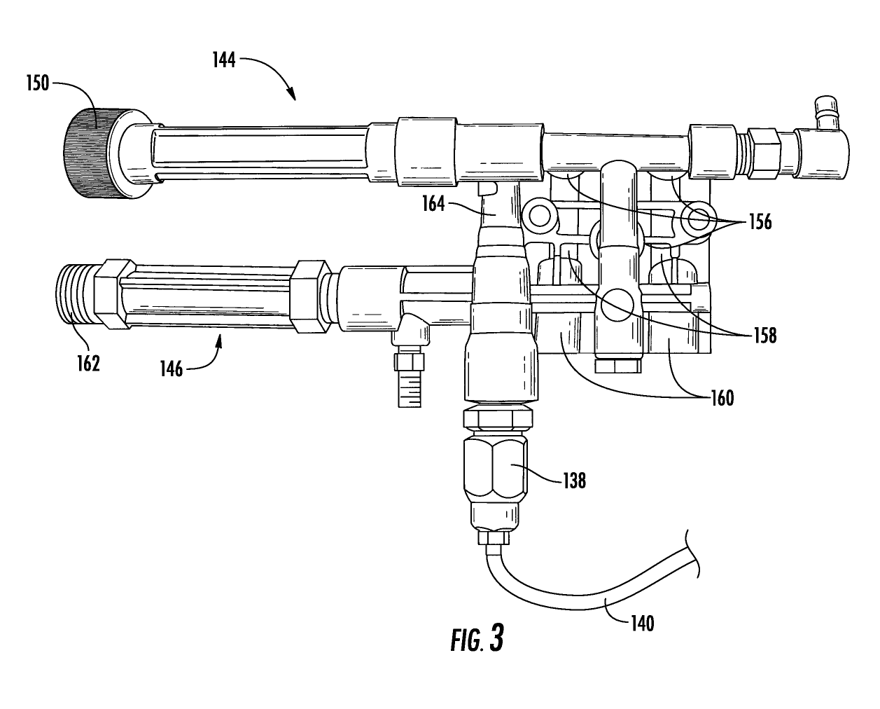

Referring to FIGS. 2-3, the water pump 116 includes an inlet 144 (e.g., inlet structure, conduit, hose coupling, etc.), a pumping mechanism 148, and an outlet 146 (e.g., outlet structure, manifold, conduit, etc.). According to an exemplary embodiment, the inlet 144 includes a hose connector 150 formed thereon, where the hose connector 150 includes a threaded female garden hose coupling, a quick-connect coupling, or another form of connector configured to facilitate attachment of a hose, a pipe, or other conduit to the inlet 144 of the water pump 116. Water enters the inlet 144 through an opening 152, and travels through a conduit 154 or conduits of the inlet, to the pumping mechanism 148.

While the pumping mechanism 148 of the pump 116 is configured to pressurize water passing therethrough, the particular structure of the pumping mechanism 148 varies in different embodiments. According to an exemplary embodiment, the pump 116 is an axial cam pump having a wobble plate configured to drive a set of three pistons that translate within respective piston chambers 156. The pistons run on two-stroke cycles, with an inlet stroke and a discharge stroke. In other embodiments, the pump 116 is another form of positive-displacement pump, such as a radial cam pump (e.g., triplex pump), a gear pump, or a scroll pump. In still other embodiments, the pumping mechanism 148 includes two or four pistons coupled to a power take-off of the combustion engine 112. In some embodiments, the pumping mechanism 148 includes an impeller (e.g., rotor, fan, etc.) of a centrifugal type pump, where the impeller rotates to accelerate water injected near the center of the impeller and ejected near the periphery of the impeller. Still other commercially-available fluid pumps and pumping mechanisms may be used.

Referring again to FIGS. 2-3, following the pumping mechanism 148, the water flows to the outlet 146 of the pump 116. In some embodiments, the outlet 146 includes one or more piston ports 158 on a discharge end of each piston chamber 156. In some embodiments, check valves (not shown) are coupled to the piston ports 158, limiting the direction of water flowing through the check valves. A discharge manifold 160 (e.g., outlet manifold), in the flow path following the check valves, joins the water discharged from piston ports 158. In some embodiments, the outlet 146 of the pump 116 further includes a hose connector 162 for coupling the high-pressure hose 122 (or other conduit) to the pump 116.

According to an exemplary embodiment, the unloader 138 may be attached to the discharge manifold 160, proximate to a bypass conduit 164 extending between the inlet 144 and the outlet 146 of the pump 116. With regard to the pump 116 of FIGS. 2-3 or a like pump, the unloader 138 is configured to control fluid access to the bypass conduit 164. Access is controlled in response to a change sensed by the unloader 138 in the water pressure differential of the pressure in the high-pressure hose 122, between the pump 116 and the spray gun 120, relative to the pressure in the pump 116. When the pump 116 is running but the spray gun 118 is not spraying, back pressure in the high pressure hose 122 exceeds the water pressure in the pump 116, and the unloader 138 opens the bypass conduit 164. Water in the outlet 146 flows back to the inlet 144 through the bypass conduit 164. Recirculation of the water from the outlet 146 to the inlet 144 of the pump 116 relieves pressure on components in the pressure washer system 110, including the engine 112 and the seals of the high-pressure hose 122 and spray gun 118. When the spray gun 118 resumes spraying, the water pressure differential changes (e.g. is reduced), the unloader 138 closes the bypass conduit 164, and water is directed to and out of the spray gun 118.

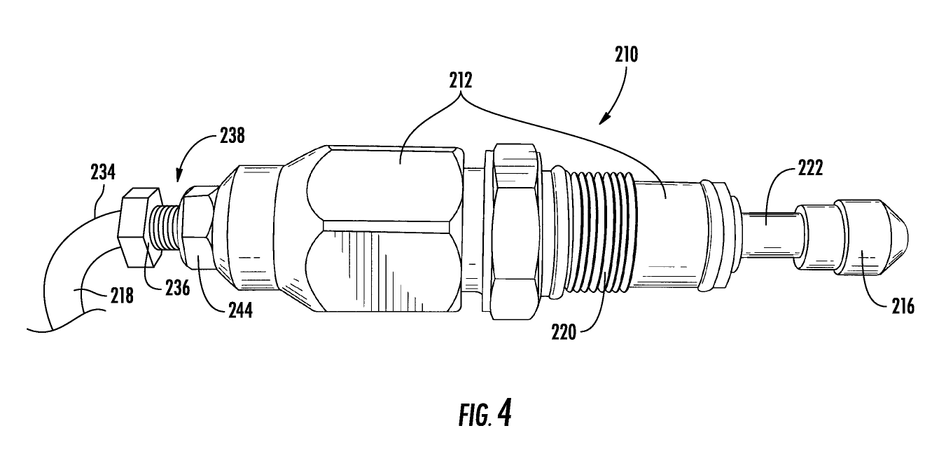

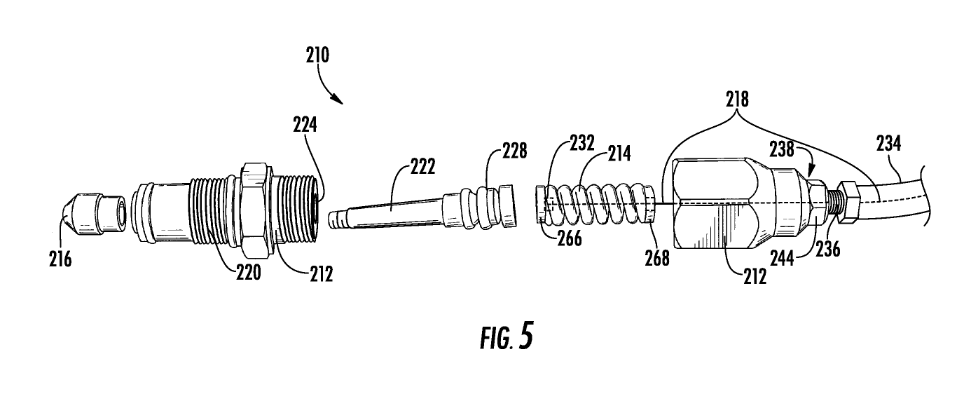

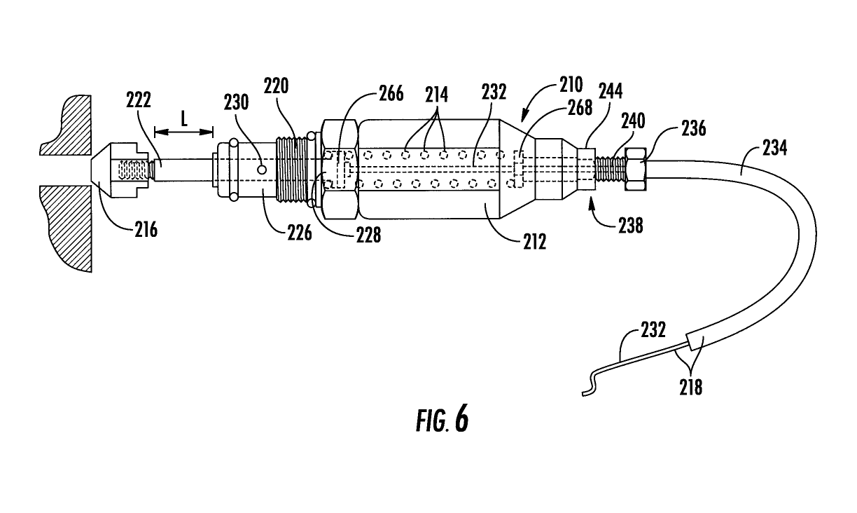

Referring now to FIGS. 4-6 an unloader according to another embodiment is shown as unloader 210. Unloader 210 includes a housing 212, a spring 214 (FIGS. 5-6), a spring adjustment mechanism 238, a valve plug 216, and a link 218. The valve plug 216 may be inserted through an opening in an outlet of a pump, such as a discharge manifold of the pump or other plumbing (see, e.g., discharge manifold 160 as shown in FIGS. 2-3). The housing 212 of the unloader 210 includes a portion 220 (e.g., threaded portion) configured to attach to the pump (see, e.g. pump 116 as shown in FIGS. 2-3). The valve plug 216 is coupled to a valve stem 222, which extends through an opening 224 in the housing 212 of the unloader 210. The spring 214 of the unloader 210 biases the valve plug 214 by loading the valve stem 222 via a lower spring support 226. The unloader 210 is configured such that when the unloader 210 is coupled to a pump, the spring 214 biases the valve plug 214 to a position blocking a bypass conduit of the pump (see, e.g., pump 116).

In some embodiments, the housing 212 of the unloader 210 is formed from two or more pieces releasably fastened together (e.g., screwed together). As shown in FIGS. 4-6, the spring 214 of the unloader 210 is positioned within the housing 212, but in other embodiments, a spring is positioned outside of a housing of the unloader. Also within the housing 212 of the unloader 210, a chamber 226 is formed between walls of the housing 212 and a plunger 228 (e.g., piston) on the end of the valve stem 222. An aperture 230 (see FIG. 6) in the walls of the housing 212 allows water to fill the chamber 226.

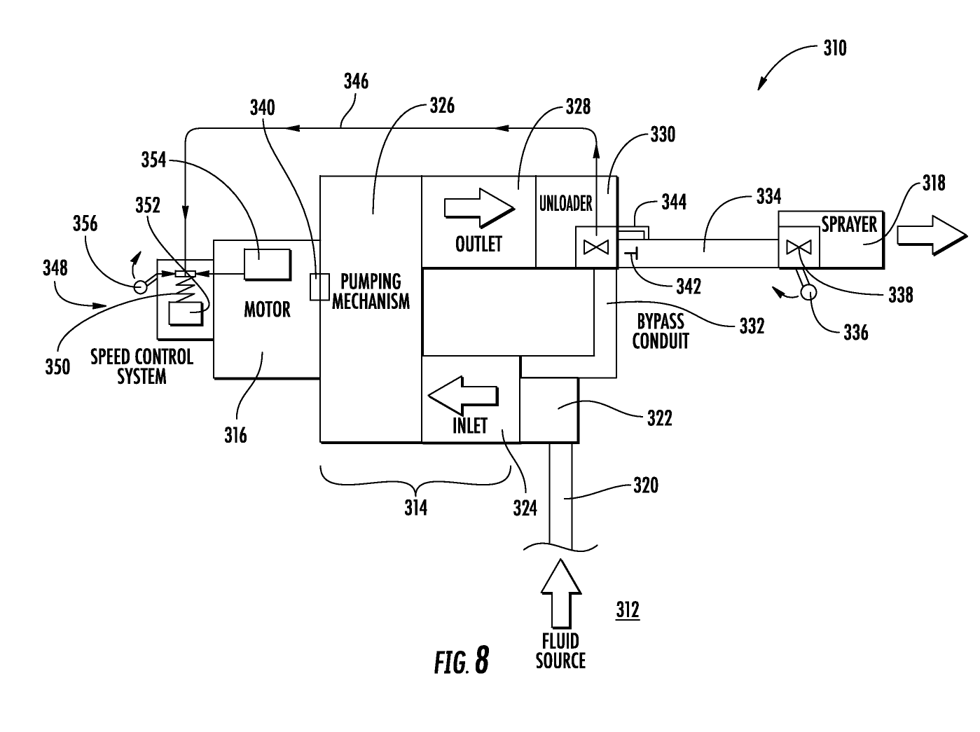

When the unloader 210 has been inserted into a pump, the unloader 210 may be positioned such that the water filling the chamber comes from water that has passed a check valve (see, e.g., check valve 342 as shown in FIG. 8) located between the unloader 210 and the high-pressure hose (see, e.g., hose 122 as shown in FIG. 1, and outlet 146 as shown in FIGS. 2-3) or other conduit. When the sprayer is stopped, the water between the check valve and the sprayer is trapped at a high pressure (e.g., back pressure), which is experienced in the chamber 226. With sufficient pressure, the water of the chamber 226 translates the plunger 228, pushing the lower spring support 266 and overcoming the bias of the spring 214. Translation of the plunger 228 in turn moves the valve plug 216, opening the bypass conduit and allowing for recirculation of water in the pump.

Referring to FIGS. 4-6, the unloader includes the adjustment mechanism 238, which is configured to adjust loading of the spring 214. The adjustment mechanism 238 includes a threaded shaft 240 having a hexagonal end 236 (or other end configured to be rotated via wrench, or otherwise rotated), and an end platform or surface on an end of the shaft 240 configured to contact an upper spring support 268 adjacent to an end of the spring 214. The threaded shaft 240 is threaded into the housing 212, and may be rotated relative to the housing 212 to move the upper spring support 268, in order to increase or decrease loading on spring 214. Once a desired spring loading is attained, a jam nut 244 (e.g., locking nut) may be tightened to lock the adjustment mechanism 238. Accordingly, the amount of back pressure sufficient to overcome the spring 214 in order to move the valve plug 216 is adjustable via the adjustment mechanism 238. Other embodiments include different types of adjustment mechanisms, such as an electrically-actuated solenoid that shifts a platform coupled to the spring. Still other embodiments do not include a mechanism for adjusting loading of the spring 214. In such embodiments, tension may be adjusted by replacing the spring with a stronger or weaker spring.

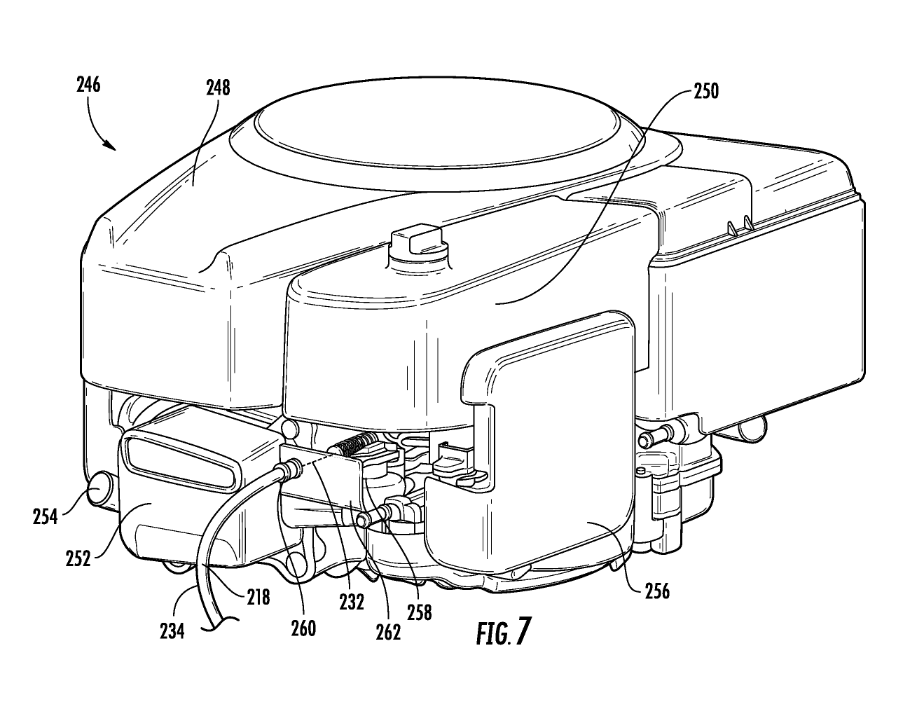

Movement, position, or orientation of the valve plug 216 of the unloader 210 may be communicated via the link 218. According to the exemplary embodiment of FIGS. 4-6, the link 218 includes a Bowden cable having an inner wire 232 (e.g., steel coil) and an outer sheath 234. According to an exemplary embodiment, the outer sheath 234 is fastened to a nut or barrel adjuster that is able to shift the outer sheath 234 relative to the inner wire 232 (see, e.g., nut 260 as shown in FIG. 7). The inner wire 232 extends through an aperture (e.g., canal, tunnel, conduit, etc.) in the threaded shaft 240 and upper spring support 268. The inner wire 232 further extends to attach to the lower spring support 266, or a fastening structure 264 that is coupled either directly or indirectly to the plunger 228. As the plunger 228 moves in response to changes in the water pressure, the inner wire 232 translates relative to the outer sheath 234.

According to an exemplary embodiment, the valve stem 222 of the unloader 210 is sized to allow for a predetermined translation L (see FIG. 6) of the plunger 228. Additionally, the spring constant and size of the spring 214 is correspondingly configured to facilitate the predetermined translation L. In some embodiments, the predetermined translation L is sufficient to move the inner wire 232 of the Bowden cable a distance required by a throttle system of an engine to control the speed of the engine (e.g., idle the engine when the valve moves into the open position). According to an exemplary embodiment, the predetermined translation L is at least an eighth of an inch and preferably at least a quarter of an inch (e.g., about a half inch). In other embodiments, mechanisms (e.g., lever, gearing, etc.) in place of or in conjunction with an elongated valve stem, may be used to scale movement of the plunger 228 to a predetermined translation distance.

Referring now to FIG. 7, an engine 246 includes a shroud 248, a fuel tank 250, a cover 252 for rocker arms of a cylinder head, an exhaust 254, an air intake 256, and other components. The fuel tank 250 is coupled to the air intake 256 via a carburetor (or other fuel injection system) within the engine 246. Fuel is burned in the engine 246, and byproducts of combustion exit the engine via the exhaust. As shown in FIG. 7, the link 218 extends from the unloader 210 of FIGS. 4-6, and is coupled to the engine 246. According to an exemplary embodiment, a spring 258 is positioned in series with the link 218 to add tension to the inner wire 232 of the Bowden cable. The outer sheath 234 of the Bowden cable may be coupled to a nut 260, or barrel adjuster, fastened to a wall 262 or other structure on the engine 246.

According to an exemplary embodiment, the inner wire 232 of the Bowden cable is coupled to a throttle control system of the engine 246 (see, e.g., throttle control system 348 as shown in FIG. 8). Movement of the inner wire 232 is used by the throttle system to control engine speed in response to the configuration of the unloader 210. In some embodiments, the inner wire 232 is coupled to a biased control lever (e.g., throttle lever) of the throttle system, where movement of the inner wire pulls the lever, overcoming the bias and adjusting the engine speed. In other embodiments, the inner wire 232 is coupled to a governor spring of the throttle system. Movement of the inner wire 232 adjusts loading on the governor spring, which may also be loaded by a governor or by the throttle lever. In still other embodiments, the inner wire 232 is coupled to a throttle plate in the carburetor of the engine, where movement of the inner wire 232 rotates the plate, controlling air flow through the carburetor. Reduction or increase of the air flow adjusts the engine speed.

Referring now to FIG. 8, a system 310 (e.g., pressure washer system, air compressor system, etc.) includes a pump 314 for pressurizing a fluid (e.g., water, air, etc.), a motor 316 (e.g., prime mover, engine, etc.) driving the pump 314, and a sprayer 318 or other component for controllably releasing the pressurized fluid. According to an exemplary embodiment, fluid from a fluid source 312 is directed to the pump 314 via a hose 320 or other conduit coupled to a connector 322 on an inlet 324 of the pump 314. Once through the inlet 324, the fluid may be pressurized by a pumping mechanism 326 of the pump 314. The pumping mechanism 326 is coupled to and is driven by a power take-off 340 of the motor 316. Following the pumping mechanism 326, the fluid passes to the outlet 328 of the pump 314, which has an unloader 330 coupled thereto. The unloader 330 controls access to a bypass conduit 332, which couples the outlet 328 of the pump 314 back to the inlet 324 such that fluid may flow through the bypass conduit 332 from the outlet 328 to the inlet 324.

The sprayer 318 includes an actuator 336 (e.g., trigger) coupled to a valve 338. The actuator 336 and the valve 338 allow a user to control when the sprayer 318 is actively spraying. When the sprayer 318 is spraying, the pressurized fluid flows past the unloader 330, past a check valve 342, and through a conduit 334 coupling the outlet 328 of the pump 314 to the sprayer 318. The fluid then flows through the valve 338 of the sprayer 318, and out of the sprayer 318 in a controlled manner. When the sprayer 318 is not actively spraying, but the engine 316 and pumping mechanism 326 are active, then trapped pressure builds up in the fluid between the valve 336 of the sprayer 318 and the check valve 342. A conduit 344 couples the fluid with increased pressure to the unloader 330, causing the unloader 330 to open fluid access to the bypass conduit 332. Fluid from the pumping mechanism 326 is redirected back to the inlet 324 of the pump 314, in a recirculation circuit. The back pressure holds the unloader 330 in the position opening the bypass conduit 344 until the back pressure is released, such as by releasing the actuator 336 of the sprayer 318.

The system 310 further includes a link 346 between the unloader 330 and a speed control system 348 of the motor 316. The link 346 between the unloader 330 and the speed control system 348 of the motor 316 may be direct or indirect, electrical, wireless, hydraulic, mechanical, etc., or combinations thereof. For example, a hydraulic link may include a conduit filled with hydraulic fluid extending between an unloader and an engine, where the ends of the conduit are capped with translatable plungers configured to communicate information between the unloader and the engine. A mechanical link may include a network of rigid mechanical structures (e.g. truss) configured to transfer movement of a valve in the unloader to a throttle system of an engine. Other links may use fiber optics and light sources coupled to a valve in the unloader. A wide variety of links may be used to couple the unloader and engine speed control. In some embodiments, the link 346 couples the unloader 330 to an intermediate component (e.g., having control circuitry) that uses input from the unloader 330, among other sources of data (e.g., time-delay clock), as a part of a logical algorithm to regulate the speed of a motor 316. According to an exemplary embodiment, the link 346 communicates the configuration (e.g., orientation, position, movement, state, etc.) of the unloader 330 to the speed control system 348 such that when the unloader 330 opens the bypass conduit 332, the speed of the motor 316 is reduced, and when the unloader 330 is blocking the bypass conduit 332, the motor speed is increased.

According to an exemplary embodiment, the speed control system 348 includes a governor spring 350, a throttle plate 352, a governor 354, and a throttle lever 356. In some embodiments, the link 346 may be coupled to or able to adjust at least one of the governor spring 350, the throttle plate 352, and the throttle lever 356. In an exemplary embodiment, the link 346 is coupled to an end of the governor spring 350, where the throttle lever 356 and a governor 354 are also coupled to the governor spring 350. Tension in the governor spring 350 biases the throttle plate 352, to control the flow of fuel and air to the motor 316, controlling the speed of the motor 316. When the unloader 330 opens the bypass conduit 332, the governor spring 350 is loaded to bias the throttle plate 352 to a closed position, idling the motor 316. When the unloader 330 is blocking the bypass conduit 332, the governor spring 350 is loaded to bias the throttle plate 352 to an opened position, throttling the motor 316. In other embodiments, the link 346 is coupled to a potentiometer, which adjusts the amount of electricity to an electric motor driving the pump. In still other embodiments, the link 346 is coupled to a second plate, separate from the throttle plate coupled to the governor and throttle lever. Still other embodiments use components or systems of components to control motor speed based upon information provided by the link 346.

The construction and arrangement of the system for pressurizing a fluid, as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A pressure washer system, comprising:
an engine having a throttle system configured to control the speed of the engine;
a water pump comprising an inlet, a pumping mechanism, and an outlet, the pumping mechanism configured to be driven by the engine;
a sprayer coupled to the outlet of the water pump;
an unloader configured to direct water toward the inlet of the water pump when the unloader is in a first configuration, and to direct water toward the sprayer when the unloader is in a second configuration, wherein water pressure generated when the sprayer is not actuated moves the unloader to the first configuration; and
a link coupling the unloader and the throttle system of the engine, wherein the link is configured to adjust the throttle system to a first engine speed when the unloader is in the first configuration, and to adjust the throttle system to a second engine speed when the unloader is in the second configuration.

2. The pressure washer system of claim 1, wherein the first engine speed is an idle speed and the second engine speed is greater than the idle speed.

3. The pressure washer system of claim 2, wherein the link comprises a Bowden cable having an inner wire and an outer sheath.

4. The pressure washer system of claim 3, wherein the unloader comprises a valve plug and the inner wire of the Bowden cable is coupled to the valve plug.

5. The pressure washer system of claim 4, wherein the valve plug is coupled to a valve stem configured to produce a translation of the valve plug of a predetermined distance when the unloader changes from the first configuration to the second configuration, and wherein the predetermined distance is at least a quarter of an inch.

6. A system for pressurizing a fluid, comprising:
an engine having a throttle system configured to control the speed of the engine;
a pump comprising an inlet, a pumping mechanism, and an outlet, the pumping mechanism driven by the engine;
an unloader coupled to the pump and configured to open a bypass conduit directing fluid from the outlet of the pump to the inlet of the pump when the unloader is in a first configuration, and to close the bypass conduit when the unloader is in a second configuration; and
a link coupling the unloader to the throttle system of the engine, wherein the link is configured to adjust the throttle system to a first engine speed when the unloader is in the first configuration, and to adjust the throttle system to a second engine speed when the unloader is in the second configuration.

7. The system of claim 6, wherein the first engine speed is an idle speed and the second engine speed is greater than the idle speed.

8. The system of claim 7, wherein the unloader comprises a movable valve plug, and wherein the link is coupled to the valve plug such that the link adjusts the throttle system in response to movement of the valve plug.

9. The system of claim 8, wherein the link comprises a Bowden cable fastened to a lower spring support coupled to a spring of the unloader configured to bias the valve plug.

10. The system of claim 9, wherein the Bowden cable is also coupled to a governor spring of the engine, and wherein the governor spring is coupled to a throttle plate, whereby movement of the valve plug changes tension in the governor spring, which adjusts the throttle plate.

11. The system of claim 10, wherein the pumping mechanism comprises at least one of a piston and an impeller.

12. The system of claim 10, wherein the pump is at least one of an axial cam water pump and a triplex water pump.

13. An unloader system for use with a pump, comprising:
a housing configured to be fastened to an outlet of the pump;
a valve plug having a first position and a second position relative to the housing;
a spring biasing the valve plug toward the second position; and
a link coupled to the valve plug, wherein the link is configured to communicate movement of the valve plug to control the pump.

14. The unloader system of claim 13, wherein the valve plug includes an extension configured to produce a translation of the valve plug of a predetermined distance when the valve plug moves from the first position to the second position.

15. The unloader system of claim 14, wherein the predetermined distance is at least a quarter of an inch.

16. The unloader system of claim 15, wherein in the link includes a Bowden cable comprising an inner wire and an outer sheath, the inner wire translatable relative to the outer sheath.

17. The unloader system of claim 16, further comprising an adjustment mechanism including a threaded shaft extending through a treaded aperture in the housing and positioned in series with the spring such that rotating the threaded shaft relative to the housing alters tension in the spring.

18. The unloader system of claim 17, wherein the inner wire of the Bowden cable extends into the housing of the unloader and is coupled to the valve plug.

19. The unloader system of claim 18, wherein the outer sheath of the Bowden cable is fastened to at least one of a nut and a barrel adjuster.

20. The unloader system of claim 19, wherein the housing is configured to be fastened to the outlet of the pump via a male threaded portion on an exterior of the housing that is configured to be coupled to a port in a discharge manifold of the outlet of the pump.
